(19) United States
(12) Patent Application Publication
(10) Pub. No.: US 2008/0109804 A1
(43) Pub. Date: May 8, 2008

(54) Additional uses of virtualization for disaster recovery and prevention

(76) Inventors: Richard Welcher Bloomstein, Highland Park, IL (US); Jason Robert Bloomstein, Mountain View, CA (US)

Correspondence Address: RICHARD W. BLOOMSTEIN, 1443 CAVELL STREET, HIGHLAND PARK, IL, 60035-2807, US

(21) Appl. No.: 11/981,156

(22) Filed: Oct. 30, 2007

Related U.S. Application Data
(60) Provisional application No. 60/857,096, filed on Nov. 6, 2006.

(51) Int. Cl. G06F 9/455

(52) U.S. Cl. 718/1

(57) ABSTRACT

Methods directed to computer disaster recovery and prevention using virtual machine and related technologies. Storage is reduced in disaster recovery dress rehearsal and testing simplified by using copy-on-write and redirection of intercepted reads and writes. Disasters arising from program changes are prevented by comparison and analysis of intercepted calls to previously unknown behavior scripts. A high level of data security is achieved by preventing transmission, copying, or storage of unencrypted forms.

### CROSS REFERENCE TO RELATED APPLICATIONS

This application claims the benefit of PPA 60/857,096 filed Nov. 6, 2006 by the present inventors

### STATEMENT REGARDING FEDERALLY SPONSORED RESEARCH OR DEVELOPMENT

Not Applicable,

### REFERENCE TO SEQUENCE LISTING, A TABLE, OR A PROGRAM LISTING COMPACT DISC APPENDIX

Not Applicable,

### BACKGROUND OF THE INVENTION

1. Field of Invention

This invention relates to computer methods using virtual machine or similar technologies.

2. Prior Art

Virtualization is a well-documented computer technique and its normal use in supervising the execution of application programs and the operating systems is well known. The emphasis in virtualization has been toward efficient execution, accurate production, and flexibility in resource allocation. The systems, methods, and algorithms presented below take advantage of the virtual environment not to reproduce the production of application programs accurately but to alter their execution to: 1) enhance disaster recovery rehearsal, 2) simplify program testing, 3) prevent or reduce the occurrence of disasters due to program errors, and 4) provide a high level of security for sensitive data.

3. Objects and Advantages

The first objective of the proposed invention is to perform disaster recovery rehearsals in a manner that reduces data storage. Critical computer applications often require redundant equipment and carefully planned procedures to insure continued operation even after failure of one or more components. In typical configurations, data is replicated as many as four times to allow high reliability. One of the four replications is present solely to allow a disaster recovery rehearsal that often lasts a few minutes a day. By using virtualization to copy certain images of data, the fourth replication can be eliminated at a significant cost saving.

The second objective is to enable programs to be tested with full but safe access to production data storage. Currently, program tests often require large duplicate storage facilities and elaborate procedures to prevent damage to production data.

The third objective of the proposed invention is to protect systems and applications from disasters arising from well intentioned as well as from malicious programs. Currently software prevents a limited number of disasters because it only identifies known malicious actions or code sequences. Most program damage arises from well-intentioned changes whose adverse effects cannot be easily recognized in advance by the current approaches. Two of the proposals to minimize damage due to changes are believed to be revolutionary. One solves the problem of detecting logical behavior in what is essentially a machine code emulator. The second permits a virtual machine monitor to determine which behavior may be permitted in one set of circumstances but prohibited in another.

The fourth objective of the proposed invention combines encryption and virtual machine environments to increase the security of sensitive data. Data encryption cannot provide security when people short-circuit the procedures used to implement it. Part of the problem is human nature, part is administrative, and part is mechanical. Systems, methods, algorithms and new components proposed may be added to virtual machine environments to guarantee much better security of sensitive data.

### BRIEF SUMMARY OF THE INVENTION

In accordance with the present invention methods are described that reduce storage requirements for disaster recovery dress rehearsal, simplify program testing, protect against damage arising from program changes, and increase the security of sensitive data.

### BRIEF DESCRIPTION OF THE SEVERAL VIEWS OF THE DRAWING

FIG. 1 shows a typical configuration of two computers permitting disaster recovery including dress rehearsal.

FIG. 2 shows an improved configuration. Minimal data storage (17) replaces the duplicate remote storage array (14) in FIG. 1 that had been used solely for disaster recovery rehearsal.

FIG. 3 shows a configuration that permits a program to be tested (18) with full access but safe access to production data storage (3) using a small data storage area (7).

FIG. 4 shows a configuration that offers more complete protection against disasters arising from program or other coding changes. In the figure, a database application program (20) calls a database software program (22) that in turn calls an operating system (24). A virtual machine monitor (26) reviews the requests using a behavior script (28).

FIG. 5 shows a configuration with increased security of sensitive data. Data is stored (43) and transmitted in encrypted form. The virtual machine monitor (42) with security decryption at a fixed computer and a similar virtual machine monitor embedded in a laptop (45) decrypts data only as it appears on the screen (41, 44). A second laptop without a properly enabled virtual machine monitor (47) or similar security program can retrieve the data but cannot decrypt it.

1—a primary application
2—a virtual machine monitor
3—primary storage array.
4—secondary, backup storage array.
6—an optional local recovery rehearsal application
7—minimal data storage area
10—a communication link
11—a remote backup application
12—a virtual machine monitor at a backup location
13—tertiary remote backup storage array.
14—remote backup storage array “frozen” in time
16—a remote recovery rehearsal application
17—minimal remote data storage area.
18—a program or other coding being tested
20—application code such as a database application program
21—a call issued by an application, such as a request for a database record
22—a standardized called program such as a database software program
23—a routine within the standardized called program
24—an operating system
25—a service routine in the operating system
26—a virtual machine monitor
27—a routine within the virtual machine monitor
28—a behavior script
29—details of a permitted behavior
41—a computer screen with text in readable form
42—a virtual machine monitor with data security decryption
43—sensitive data stored in encrypted form
44—a laptop computer screen with text in readable form
45—a virtual machine monitor with data security decryption in a laptop computer
46—a laptop screen with text in gibberish
47—a laptop computer without a virtual machine monitor with data security

### DETAILED DESCRIPTION OF THE INVENTION

### Enhanced Disaster Recovery Rehearsal.

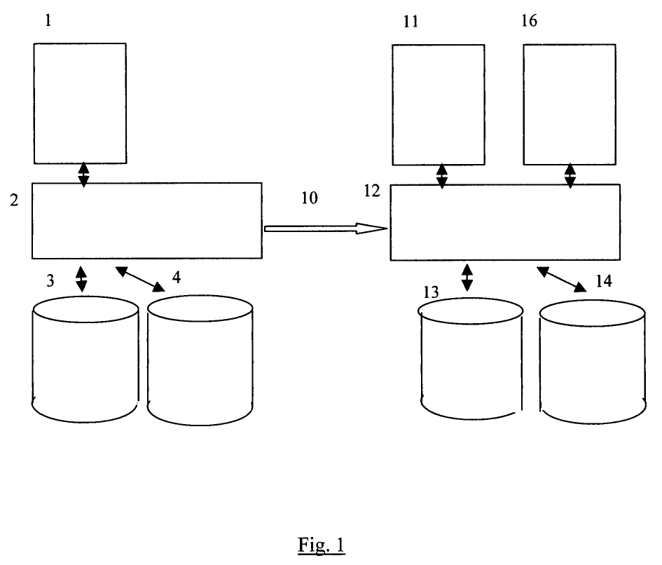

FIG. 1 shows a typical high reliability configuration running in a virtual machine environment. Under normal operation the primary application (1) operating under a virtual machine monitor (2) gets and stores its data in primary data storage array (3) and backup copies of the data in a local secondary storage array (4). The primary application (1) and virtual machine monitor (2) also communicates with a remote backup application (11) and virtual machine monitor at a backup location (12) through a communication link (10), which may be a network such as the Internet. The remote backup application (11) and virtual machine monitor (12) stores copies of the data transmitted on its storage arrays (13) and (14) which are essentially duplicates of the data on the storage arrays (3) and (4).

In the case of disaster, such as total power loss at the local host (1 through 7), operation can be switched to the remote backup location (11 through 17).

It is advisable to run periodic (say daily) recovery dress rehearsals in order to insure that the remote backup location has the necessary programs, data files, and execution scripts. Because the dress rehearsal takes place during normal operation it requires a fourth data storage array (14) that duplicates the other three (3,4, and 13).

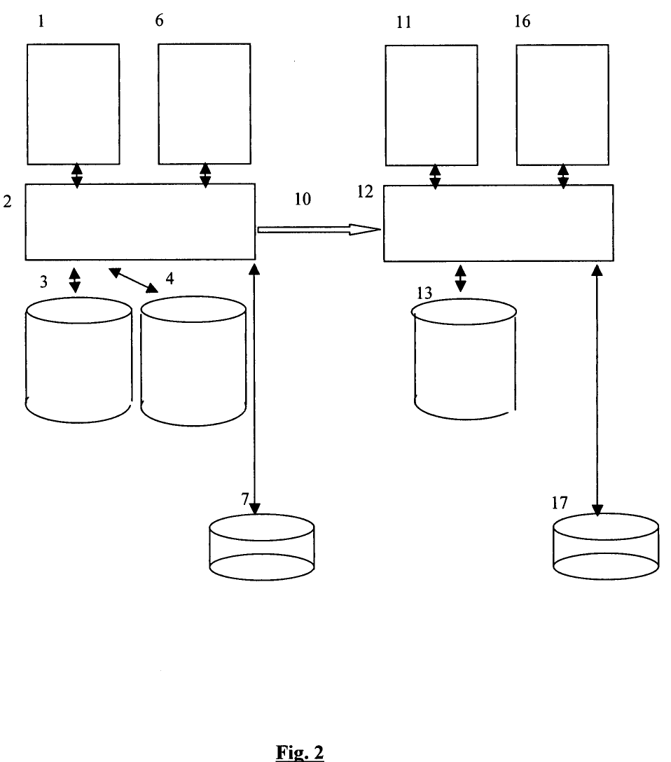

Referring to FIG. 2, in the proposed invention, a small “before image” data storage area (17), is employed instead of the rehearsal data storage array (14).

A virtual machine monitor program (12) supervising execution in the backup computer is instructed to intercept all data reads and writes. In anticipation of and during recovery dress rehearsal the “before image” of any data stored on the data storage array (13) is written to a small data storage area (17) which may be a separate device or reserved area on the data storage array (13). The “before image” data may be supplemented with the actual address of the data on the primary storage array and a time or sequence number. In executing the rehearsal script, all reads and writes are addressed to the “before image” data storage area (17). On reads, if the data addressed is not present in the before image data storage area (17) the data has not changed and is read from the data storage array (13).

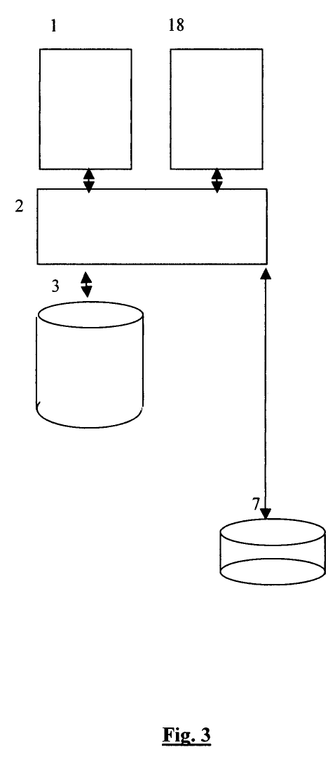

Although FIG. 3 is directed principally toward recovery rehearsal at a remote location, recovery rehearsal can also be run locally (6) requiring only minimal data storage (7). In anticipation of and during recovery dress rehearsal the “before image” of any data stored on the data storage array (3) is written to a small data storage area (7) which may be a separate device or reserved area on the data storage array (3) or (4). The “before image” data may be supplemented with the actual address of the data on the primary storage array and a time or sequence number. In executing the rehearsal script, all reads and writes are addressed to the “before image” data storage area (7). On reads, if the data addressed is not present in the before image data storage area (7) the data has not changed and is read from the data storage array (3).

The configuration just described is illustrative. Alternative configurations are possible. In the preferred embodiment the program code that traps and redirects the reads and writes is added to and embedded in a virtual machine monitor. Such program code could also be free standing and added to the rehearsal script, included in or attached to the operating system, or incorporated in one or more interpreters. Also, many storage arrays incorporate copy on write in hardware.

### Simplify Program Testing

Referring to FIG. 3, in the proposed invention, a small data storage area (7) is employed to allow a program being tested (18) to operate with live data but without damage and without the need for a massive duplicate storage array. During such testing the “before image” of any data stored on the data storage array (3) is written to a small data storage area (7) which may be a separate device or reserved area on the data storage array (3). The “before image” data may be supplemented with the actual address of the data on the primary storage array and a time or sequence number. In executing the program test, all reads and writes are addressed to the “before image” data storage area (7). On reads, if the data addressed is not present in the before image data storage area (7) the data has not changed and is read from the data storage array (3).

Although FIG. 3 is directed principally toward major testing, program testing can also be run without the data being written to the small data storage area (7) by the primary application program. An alternative embodiment and method of executing the program test is as follows. All reads and writes from the test program are addressed to the small data storage area (7) without any monitoring of the application program. On test program reads, if the data addressed is not present in the small data storage area (7) the data is read from the main data storage array (3) and a copy immediately written to the small storage array (7). Copying the addressed data into the small storage array (7) maintains the integrity of the test.

The configuration just described is illustrative. Alternative configurations are possible. In the preferred embodiment the program code that traps and redirects the reads and writes is added to and embedded in a virtual machine monitor. Such program code could also be free standing and added to the test presentation or included in or attached to a database software program, language interpreter, and/or the operating system.

### Protecting Against Disasters Arising From Program Changes

Programmers and other technicians usually attempt to test coding changes before placing the changed versions into production. Such tests are often limited by the need for extensive production data and processes.

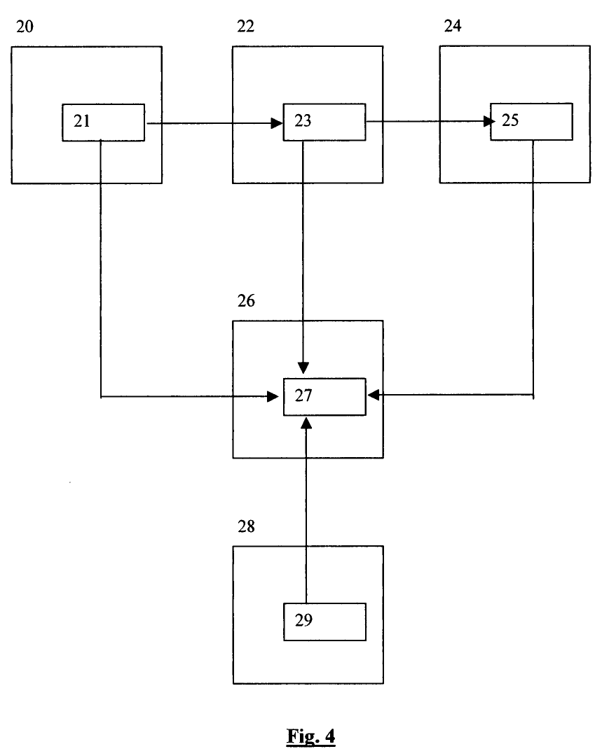

Referring to FIG. 4 an application program (20), for example, calls a standardized software program, (22) that in turn calls an operating system (24). A virtual machine monitor (26) executes all the instructions including the call (21) issued by the application program, the routine (23) within the standardized software, and the input/output service routine (25) in the operating system.

In the proposed invention specially coded behavior scripts (28) are added to allow the virtual machine monitor to distinguish between permitted and prohibited actions of the application program, the standardized software, and even the operating system.

This specially coded behavior script is a major advance over current monitoring efforts. For example, “behavior-blocking software” attempts to identify malicious program code by looking for known malicious actions that are of little relevance to common application program errors.

However, virtualization combined with what is hereafter called “application behavior recognition” can identify and control many program problems before damage is severe. Typically, most program damage occurs as a result of program changes and/or software version updates.

In the preferred embodiment virtualization, which provides a mechanism to monitor and intercept all program and operating system requests, is instructed to monitor most closely those programs and modules it identifies that have changed most recently or have questionable origin. Moreover, in the preferred embodiment, the virtual machine monitor is given access to a manually prepared “application behavior recognition and correction script” (28) for each program or module that is changed before or coincidentally with the changed version put into production. In the preferred embodiment, the script defines time periods, behaviors, and corrective actions. It is suggested that all programs, modules, etc. have behavior scripts or, by default, are covered by an application or general behavior recognition and correction script. In the preferred embodiment, the default script is restricted as defined below in behaviors and corrective actions.

The time period portion of the script identifies, typically the length of time or number of uses before program changes can be taken off the close watch list. The simplest logic is to add code to the virtual machine monitor to test the date last changed catalogued with each module as it is loaded.

The most important behaviors to monitor are input/output and other system calls issued by the program or module. Generally reads are benign, except where reads are voluminous for the application and may belie a closed loop. Write of new records may also be benign except where unusually voluminous. Deletes and rewrites, especially of control records or files or linked data chains should only if permitted in the behavior script and subject to the actions defined by the behavior script.

The remedial action portion of the script may include, for example, one or more of the following items: a backup snapshot, a detailed transaction log, and/or a copy of records before writing. Based on behavior marked as severe behavior, the action script could specify the loaded module be terminated and/or replaced by an earlier version.

One problem is to determine high level logical behavior from the low level machine code at which the virtual machine monitor operates. The proposed method solves many instances of this problem as, for example, those that occur in application programs that access databases. The proposed method tracks backward from calls to the database software, e.g. when the application program calls the database with an application parameter list including all logical functions: commands, records, fields, etc. The documentation of entry points formats of calls etc. is usually available from the software vendor. The details also can be found, if needed, by writing a simple application and inspecting the generated code. The monitor can identify the database software and the corresponding entry points as it loads modules and application programs and therefore can be instructed to analyze actions at a high level.

The virtual machine monitor intercepts all supervisor service calls. Application program file input output, for example, can be detected from the service calls and the intended behavior from the details in the associated parameter list.

In the preferred embodiment the program code that traps and reviews the behavior is added to and embedded in a virtual machine monitor. Other configurations are possible. For example, such a monitoring program could be incorporated in the standardized software program or inserted between the application program(s) and the standardized software program(s). An example of this approach can be illustrated by monitoring changes in an on-line code such as code written in a server side scripting or other interpreted language. The change monitor code could be added to the interpreter or simply act as a go between that inspects each statement before turning it over to the real interpreter.

### Increased Security of Sensitive Data

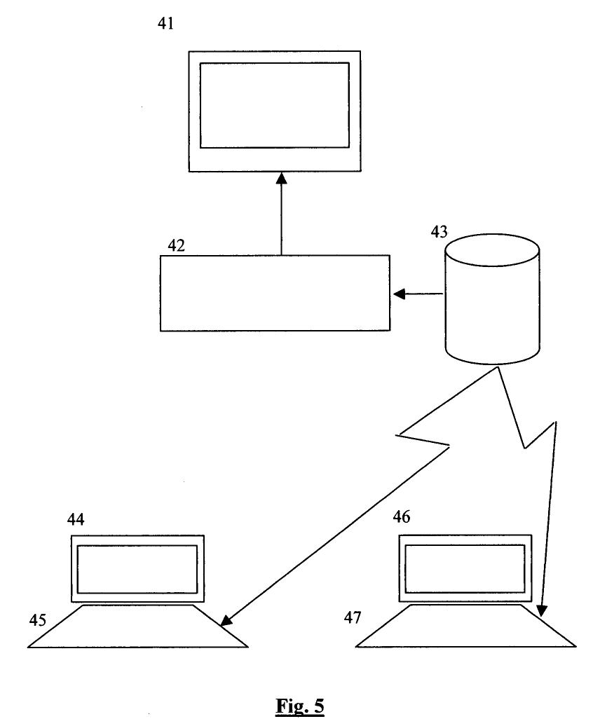

Referring to FIG. 5 a configuration with enforced use of encryption provides increased security of sensitive data (43). The virtual machine monitor (42) with security decryption at a fixed computer and a similar virtual machine monitor embedded in a laptop (45) decrypts data only as it appears on the screen (41, 44). A second laptop without a virtual machine monitor (47) can retrieve the data but cannot decrypt it. Only gibberish appears on the screen (46).

Data encryption cannot provide security of sensitive computer data when people short-circuit the procedures used to implement it. Part of the problem is human nature. People decrypt files for convenience and then, for example, take the decrypted files home for the weekend on their laptops. A second part of the problem is administrative: clear policies not universally followed by all managers and all computer application supervisors. The third is mechanical. Several files can be individually encrypted, but combining data from them may require decrypting them all into plain-text files. In addition to these problems, unencrypted email in folders on highly placed individuals' personal computers also present a risk to the company itself.

Virtualization combined with a new technique embodied in code can enforce data encryption of sensitive data within a company despite human nature. First all data known to be sensitive is stored in encrypted form, say, on company files. Second, passwords, etc. gain access to the data but not automatically perform decryption. Instead, decryption is only done on a sentence-by-sentence or screen-by-screen basis by an enhanced virtual machine monitor to which such security code is added. The virtual machine monitor may also provide specialized file searches but makes only selected results in readable form on the screen. The virtual machine monitor program disables the normal print-screen function and the normal unencrypted cut and paste functions. Decryption is done on the fly to combine data and the result immediately re-encrypted. The use of the printer may be disabled or restricted.

All execution on the machine is controllable by the virtual machine monitor program including all file input output, all network transmission, all keyboard mouse actions, and screen displays. All known sensitive data is encrypted and can be decrypted only by the company approved virtual machine monitor program. Moreover, new documents, especially those created by using, in part, data from sensitive files, are encrypted as they are stored. In the preferred embodiment, the special “sensitive data” version of the virtual machine monitor data stores and transmits all data from the computer it is monitoring in encrypted form.

The method is self-enforcing. A manager, or other special employee, uses a computer controlled by a sensitive data virtual machine monitor in order to be able to gain access to company sensitive data.

If desired a special employee can have a laptop controlled by a sensitive data virtual machine monitor that responds to his passwords etc. If the laptop is misplaced all the data is stored in encrypted form. The virtual machine monitor will not respond without passwords and the hard drive is meaningless gibberish without it. A meaningful version of the data is inaccessible to third parties.

By default, all e-mails from a sensitive data computer could be transmitted by the virtual machine monitor in encrypted form.

An alternative embodiment proposed does not require a virtual machine monitor. Instead, a specialized e-mail encrypting and decrypting program could be installed in computers, especially lap top computers, used by key personnel. The specialized e-mail program could be programmed to encrypt new e-mail compositions and display decrypted versions only as well as lock out print-screen commands. Similar versions of other programs for textual documents, blue prints, tabular data, etc. could also be programmed decrypt for display only and to encrypt before storage or transmission new and edited documents.

We claim:

1. A method of enhancing testing such as disaster recovery rehearsal in a computer system comprising:
a. providing a small “before image” data storage area;
b. intercepting data writes addressed to external storage arising from application programs executing in a computer system;
c. copying images of data to said “before image” data storage area before alteration by writes of said application programs;
d. intercepting data reads and writes arising from execution of a test such as disaster recovery rehearsal script;
e. addressing reads and writes arising from said test to the “before image” data storage area;
Thereby reducing the external data storage area required by such testing.

2. A process in claim 1 above wherein one or more of the steps requires the presence of a virtual machine monitor program.

3. A process of protecting against disasters arising from coding such as program changes comprising
a. preparing a list of permitted actions associated with applications such as programs
b. intercepting calls issued by said applications executing inside a computer
c. identifying said applications issuing said calls;
d. analyzing actions associated with said intercepted calls
e. comparing said actions associated with said intercepted calls to the permitted actions associated with said applications;
f. performing remedial action based on said comparison
Thereby reducing the damage arising from coding such as program changes.

4. A process in claim 3 above wherein one or more of the intercepting steps the presence of a virtual machine monitor program.

5. A process to increase security of sensitive data comprising:
a. providing means for encrypting sensitive data stored on files;
b. providing means for retrieving and transmitting said data in said encrypted form;
c. providing only restricted means for decrypting said encrypted data;
Thereby preventing sensitive data to be stored inadvertently in decrypted form and accessible to third parties.

6. A process in claim 5 above wherein one or more of the steps requires the presence of a virtual machine monitor program.
